(19) United States
(12) Patent Application Publication
(10) Pub. No.: US 2007/0229731 A1
(43) Pub. Date: Oct. 4, 2007

(54) DIRECT TYPE BACKLIGHT MODULE AND APPLICATION THEREOF

(75) Inventors: Wen-Chin LAN, Tainan County (TW); I Han LIU, Tainan County (TW)

Correspondence Address: LOWE HAUPTMAN BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 11/683,125

(22) Filed: Mar. 7, 2007

(30) Foreign Application Priority Data
Mar. 8, 2006 (TW) 95107796

(51) Int. Cl. G02F 1/1335

(52) U.S. Cl. 349/64

(57) ABSTRACT

A direct type backlight module and an application thereof are described. The direct type backlight module comprises a rear frame module and a light source, wherein the light source is deposed on the rear frame module. The rear frame module comprises a plurality of frameworks, wherein the frameworks are combined to form a frame. The direct type backlight module is suitable for applying in a liquid crystal display (LCD) device.

### CROSS REFERENCE TO RELATED APPLICATIONS

The present application is based on, and claims priority from, TW Application Number 095107796 filed Mar. 8, 2006, the disclosure of which is hereby incorporated by reference herein in its entirety.

### BACKGROUND OF THE INVENTION

1. Field of the Invention

The present invention relates to a direct type backlight module and an application thereof, and more particularly, to a direct type backlight module including a rear frame module and its application on a liquid crystal display (LCD).

2. Brief Description of the Related Art

Among flat panel displays, the development of liquid crystal displays is the most rapid and integrated. The front-end glass process of the liquid crystal display panel is very advanced, and the assembly techniques and the material, applied in the back-end liquid crystal module (LCM) are also improving. Currently, in addition to providing larger devices, liquid crystal display module factories also provide devices with reasonable prices to fulfill the requirements of the market. Therefore, as the throughput is greatly increased, the liquid crystal display module factories have to increasingly improve and create material, designs and assembly methods of the modules to achieve the objective of decreasing cost.

FIG. 1A and FIG. 1B respectively illustrate diagrams of the front and rear sides of a typical direct type backlight module. A typical direct type backlight module 100 is mainly composed of a rear plate 102, a light source set 104 and a reflection sheet 106, such as shown in FIG. 1A. The rear plate 108 is mainly used to carry the light source set 104 and the reflection sheet 106 and to provide screw holes for printed circuit boards 108 to fix to the backside of the rear plate 102, as shown in FIG. 1B. The rear plate 102 is usually composed of a metal plate, such as an aluminum plate or a steel plate, and is formed in one piece, as shown in FIG. 3A and FIG. 3B. The light source set 104 is typically composed of several cold cathode florescent lamps to provide light.

FIG. 2 is an exploded view of a typical backlight module. In the assembly of the backlight module 100, the reflection sheet 106 is adhered to the front of the rear plate 102, and the light source set 104 composed of several lamps is disposed over the reflection sheet 106 on the front of the rear plate 102. The reflection sheet 106 is located under the light source set 104, so that the light emitted towards the rear plate 102 by the light source set 104 is reflected towards the front of the backlight module 100. Subsequently, the printed circuit boards are fixed to the back of the rear plate 102 with screw holes set in the back of the rear plate 102.

The rear plate is typically composed of an aluminum plate or a steel plate, and is formed in one piece. The aluminum plate is light, but is expensive and has a low structural strength. The steel plate is cheap and has a stronger structural strength, but is very heavy. As a result, the transport cost of the rear plate is increased, and it is unfavorable to the lightening of the design.

Currently, in addition to the direct type backlight module, there is a edge-lighted type backlight module. In the edge-lighted type backlight module, a light guide plate is used to guide the light emitted from the side of the backlight module towards the display surface. In addition to the light guide function, the light guide plate can carry optical films and increase the structural strength of the backlight module. As compared with the edge-lighted type backlight module, a space is formed in the rear plate of the direct type backlight module, and the light source set is placed in this space, so that the direct type backlight module includes no light guide plate. As a result, the structural strength of the direct type backlight module is generally provided by the rear plate. Therefore, the weight and strength designs of the direct type backlight module are very important.

### SUMMARY OF THE INVENTION

In view of the defects of the rear plate of the conventional backlight module, one aspect of the present invention is to provide a direct type backlight module, in which a frame composed of a plurality of frameworks (or frame elements) is adopted to replace the conventional rear plate, so that the weight of the backlight module is greatly decreased to achieve a lightening effect.

Another aspect of the present invention is to provide a direct type backlight module, in which frameworks composed of a metal material, such as a steel material, or a nonmetal material, such as a plastic material mixed with glass fibers, may be used to form a rear frame module, so that the cost is reduced, and sufficient structural strength is provided.

Still another aspect of the present invention is to provide a liquid crystal display, in which a backlight module includes a rear frame module composed of frameworks (or frame elements), and the frameworks are composed of a high strength material, so that the material is used economically without decreasing the structural strength of the rear frame module. Therefore, the waste of material is reduced, the cost of the liquid crystal display is decreased, and the liquid crystal display is lightened.

According to the aforementioned aspects, the present invention provides a direct type backlight module, comprising: a rear frame module comprising a plurality of frameworks, wherein the frameworks are combined to form a frame; a light source disposed on the rear frame module; a reflection sheet disposed between the rear frame module and the light source; a diffusive plate (viz., a light diffusing plate) disposed on the light source; and an optical film set disposed on the diffusive plate.

According to a preferred embodiment of the present invention, the rear frame module further comprises at least one auxiliary framework, and two ends of the auxiliary framework are respectively connected to two opposite frameworks.

According to another preferred embodiment of the present invention, the rear frame module further comprises a supporting plate disposed on the frame and connected with the frame.

According to the aforementioned aspects, the present invention provides a liquid crystal display comprising a direct type backlight module and a liquid crystal panel module disposed on the direct type backlight module. The direct type backlight module comprises: a rear frame module comprising a plurality of frameworks, wherein the frameworks are combined to form a frame; a light source disposed on the rear frame module; a reflection sheet disposed between the rear frame module and the light source; a diffusive plate disposed on the light source; and an optical film set disposed on the diffusive plate.

According to an embodiment of the present invention, the rear frame module further comprises a plurality of auxiliary frameworks, wherein two ends of each auxiliary frameworks are respectively connected to two opposite frameworks, and at least one of the frameworks is connected to one of the auxiliary frameworks adjacent to and juxtaposed with said framework. This at least one framework comprises a connection structure connected to the adjacent auxiliary framework to form a functional framework, wherein the connection structure can provide a larger area for the setting of other devices or fixing holes.

By using the frame module composed of frameworks as the supporting structure of the backlight module, the weight of the backlight module is decreased, the waste of the material is reduced, and sufficient structural strength is provided. Therefore, the backlight module is lightener and the cost of the liquid crystal display is reduced without degrading the structural strength of the backlight module.

### BRIEF DESCRIPTION OF THE DRAWINGS

The foregoing aspects and many of the attendant advantages of this invention will be readily appreciated as the same become better understood by reference to the following detailed description, when taken in conjunction with the accompanying drawings, wherein:

FIG. 1A is perspective view of a front side of a typical direct type backlight module;

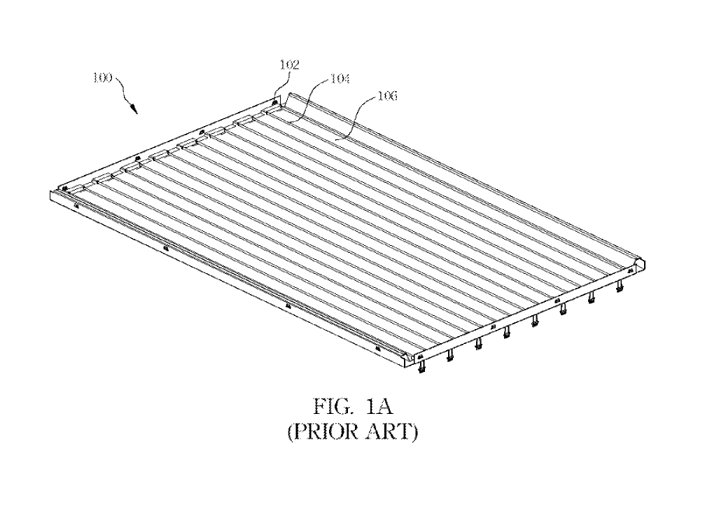

FIG. 1B is a perspective view of a backside of the direct type backlight module shown in FIG. 1A;

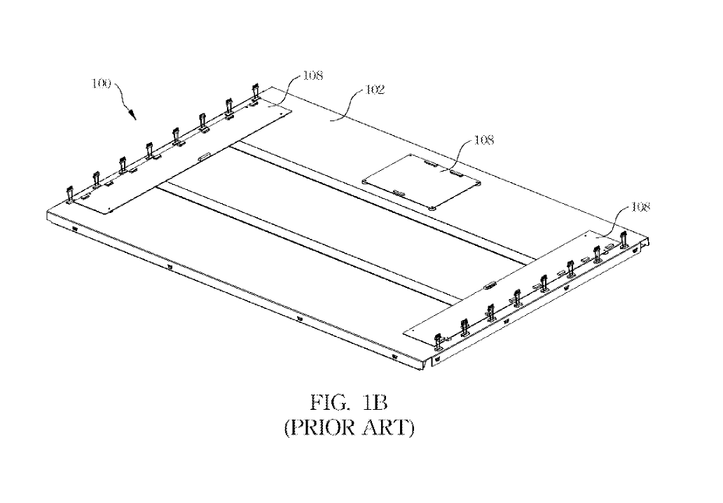

FIG. 2 is an exploded view of a typical backlight module;

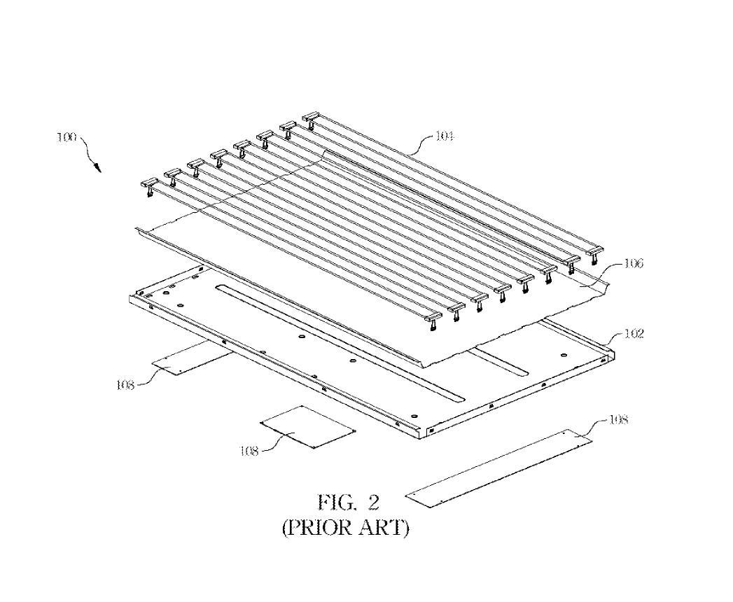

FIG. 3A is a perspective view of a front of a rear plate of a typical direct type backlight module;

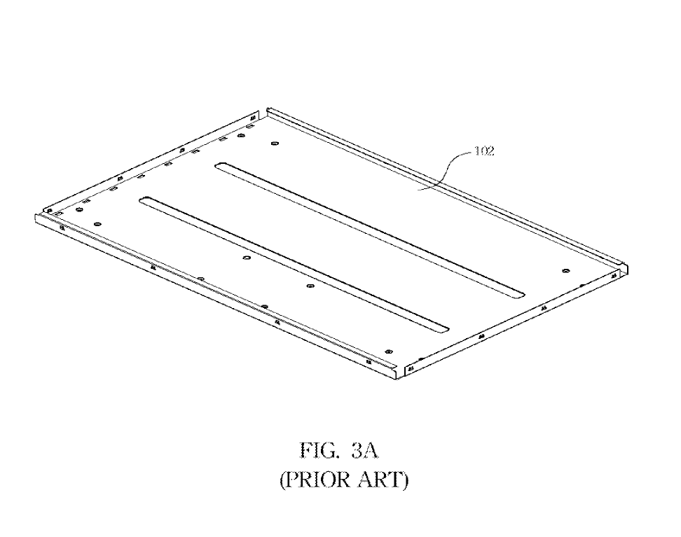

FIG. 3B is a perspective view of the rear of the rear plate shown in FIG. 3A;

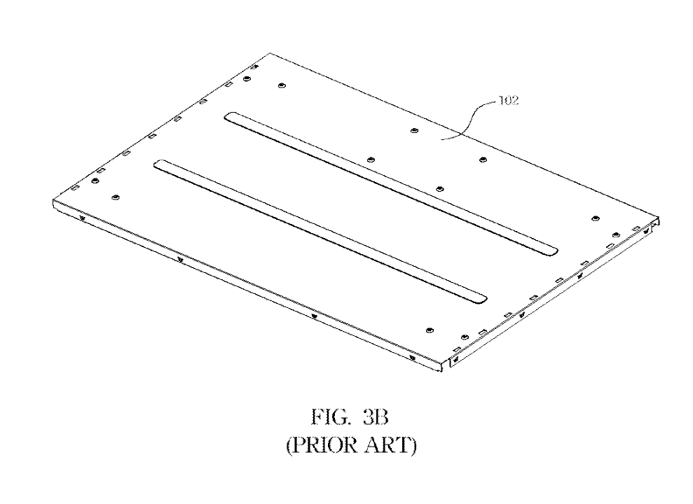

FIG. 4A is a perspective view of a rear of a frame module of a direct type backlight module in accordance with a preferred embodiment of the present invention;

FIG. 4B is an exploded view of a rear frame module of a direct type backlight module shown in FIG. 4A;

FIG. 5A is a perspective view of a rear frame module of a direct type backlight module in accordance with another preferred embodiment of the present invention;

FIG. 5B is an exploded view of the back of a rear frame module of a direct type backlight module shown in FIG. 5A;

FIG. 6A is a view of a rear frame module of a direct type backlight module in accordance with still another preferred embodiment of the present invention;

FIG. 6B is an exploded view of the back of a rear frame module of a direct type backlight module shown in FIG. 6A;

FIG. 6C shows a supporting plate of a direct type backlight module in accordance with the embodiment of FIGS. 6A and 6B; and

FIG. 7 is an exploded view of a liquid crystal display in accordance with a preferred embodiment of the present invention.

### DETAILED DESCRIPTION OF THE PREFERRED EMBODIMENT

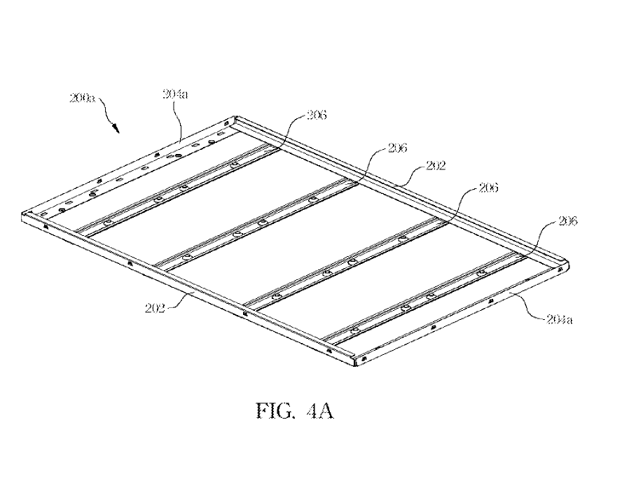

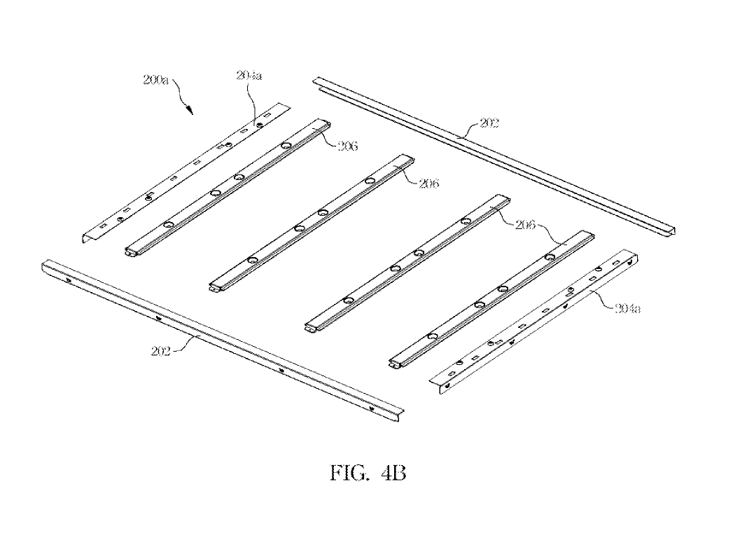

The embodiments of the present invention relate to a direct type backlight module and an application thereof. The direct type backlight module comprises a rear frame module to replace the conventional rear plate, so that the backlight module is lightener, the material consumption of the rear plate is less, the cost of the backlight module is reduced, and a compact liquid crystal display is achieved. In order to make the illustration of the present invention more explicit, the following description is stated with reference to FIG. 4A through FIG. 7.

Referring to FIG. 4A and FIG. 4B simultaneously. FIG. 4A illustrates a diagram of a rear frame module of a direct type backlight module in accordance with a preferred embodiment of the present invention. FIG. 4B is an exploded view of the module. A direct type backlight module of the present exemplary embodiment is mainly composed of a rear frame module 200a and a light source deposed on the front of the rear frame module 200a. In the present exemplary embodiment, the rear frame module 200a is a frame structure and mainly comprises two pairs of frameworks 202 and 204a, wherein the frameworks 202 and 204a are combined to form a frame. The two frameworks 202 are substantially equal in length and are set on opposite sides of the frame, and the two frameworks 204a are substantially equal in length and are respectively set on the other sides of the frame, so that the frameworks 204a in the frame are also opposite to each other, such as shown in FIG. 4A. The frameworks 202 and 204a may be connected by any suitable methods known by persons skilled in the art, wherein these methods includes connecting by using screws, rivets, rivet joints, various welds or a third material, gluing or sticking. The material of the frameworks 202 and 204a may be metal material or nonmetal material, wherein the metal material may be steel material, such as SECC, and the nonmetal material may be plastic material mixed with glass fibers.

In the exemplary embodiment, at least one auxiliary framework 206 is selectively added to the frame of the rear frame module 200a according to the required structural strength of the backlight module in the practical application to increase the structural strength of the rear frame module 200a, such as shown in FIG. 4A. However, in the other embodiments of the present invention, if the frame structure composed of four outer frameworks has met the strength requirement of the apparatus, it is unnecessary to set any auxiliary framework. Two ends of each auxiliary framework 206 are respectively connected to two opposite frameworks of the frame of the rear frame module 200a, such as the frameworks 202. As a result, the auxiliary framework 206 is juxtaposed with the pair of the frameworks 204a. Similarly, the auxiliary framework 206 may be connected by any suitable method known by persons skilled in the art, wherein these methods includes connecting by using screws, rivets, rivet joints, various welds or a third material, gluing or sticking. In the present exemplary embodiment, the material of the auxiliary framework 206 may be a metal material or a nonmetal material, wherein the metal material may be steel, such as SECC (i.e. Steel, Electrogalvanized, Cold Rolled, Coil) , and the nonmetal material may be plastic mixed with glass fibers.

The present exemplary embodiment uses the frame composed of frameworks as the rear supporting structure of the backlight module, so that by designing the thickness and the geometry of the frameworks, the weight of the backlight module is decreased, the material of the rear supporting structure is saved, the waste of the sheet material of the rear supporting structure is reduced, the cost of the rear supporting structure is decreased, and the backlight module is lightened without degrading the structural strength of the backlight module.

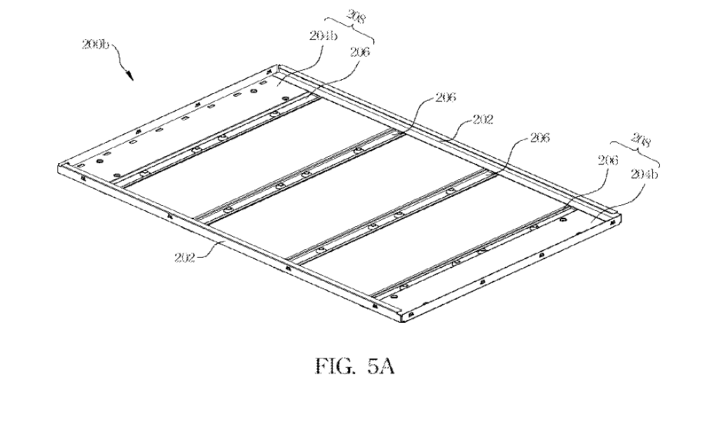

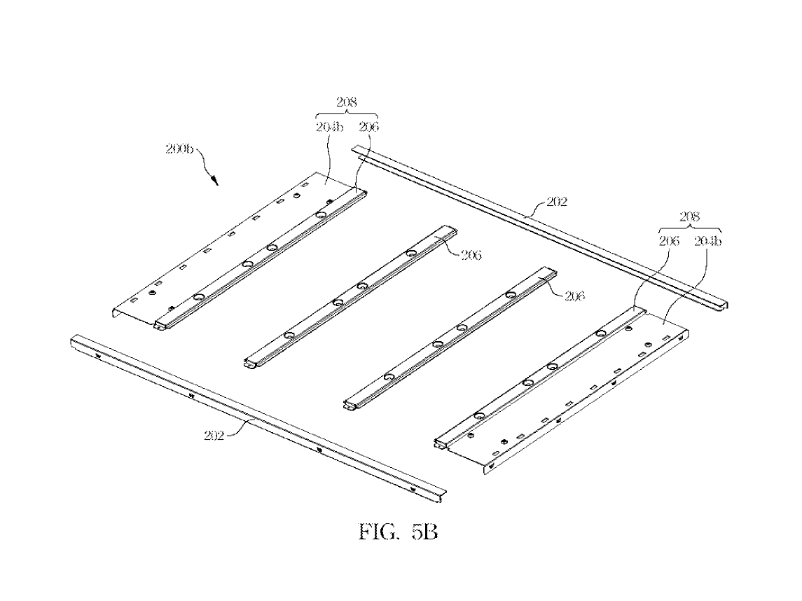

The rear frame structure of the direct type backlight module of the present invention can be modified according to the structural strength requirement of the backlight module. Referring to FIG. 5A and FIG. 5B simultaneously, in which FIG. 5A illustrates a diagram of a rear frame module of a direct type backlight module in accordance with another preferred embodiment of the present invention, and FIG. 5B is an exploded view of the module. In a rear frame module 200b, the two frameworks 204b juxtaposed with the auxiliary frameworks 206 are respectively combined with the adjacent auxiliary frameworks 206 to form functional frameworks 208, such as shown in FIG. 5A. In the functional frameworks 208, one side of each framework 204b extends toward the interior of the rear frame module 200b and is integrated with the adjacent auxiliary framework 206, such as shown in FIG. 5B. Therefore, the structural strength of the rear frame module 200b is increased, and a larger area is provided for use, such as for the setting of screw holes of a circuit board. In the present invention, there may be only one of the frameworks 204b combined with the adjacent auxiliary frameworks 206 to form a functional framework 208. The framework 204b and the auxiliary framework 206 constructing the functional framework 208 may be combined by a connection method or may be formed in one piece.

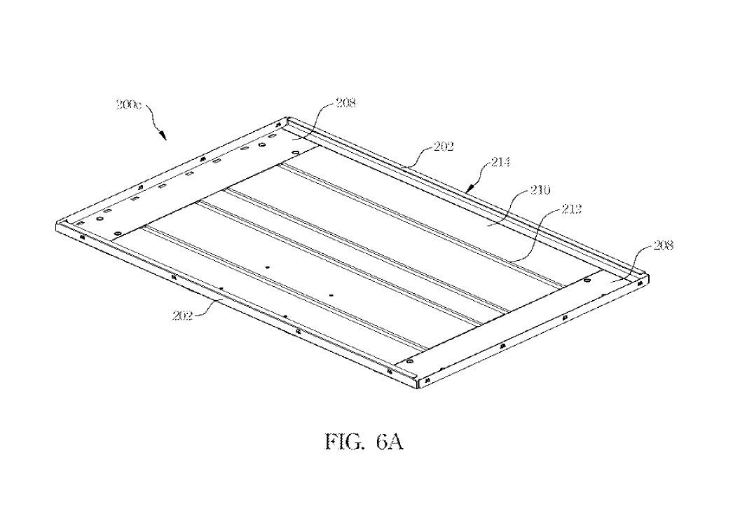

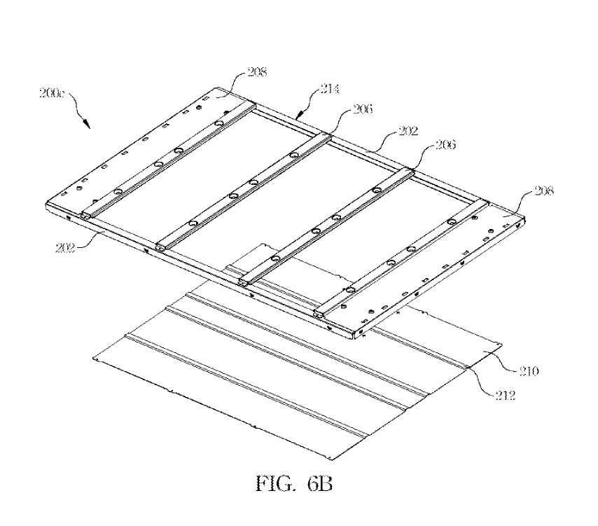

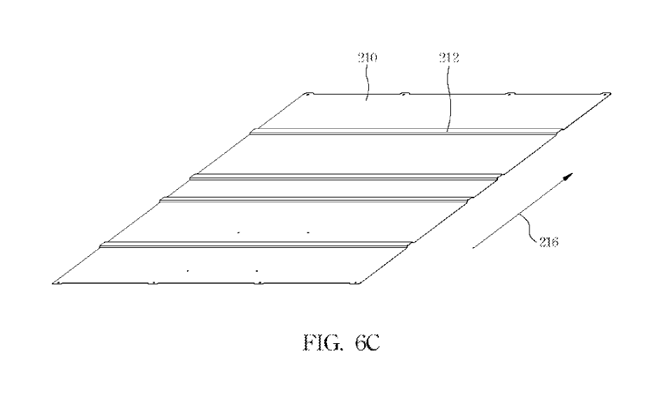

Referring to FIG. 6A and FIG. 6B, in which FIG. 6A illustrates a diagram of a rear frame module of a direct type backlight module in accordance with still another preferred embodiment of the present invention, and FIG. 6B is an exploded view the module. A rear frame module 200c is mainly composed of a frame 214 as that of the rear frame module 200b and a supporting plate 210, wherein the supporting plate is fixed to the front of the frame 214 to enhance the whole structural strength of the rear frame module 200c, such as shown in FIG. 6A and FIG. 6B. The supporting plate 210 and the frame 214 may be connected by any suitable method known by persons skilled in the art, wherein these methods includes connecting by using screws, rivets, rivet joints, various welds or a third material, gluing or sticking. The supporting plate 210 may be composed of a thinner metal plate, and is preferably composed of a steel material to increase the structural strength and to reduce the cost. In one embodiment, a reflecting layer may further be coated on the supporting plate 210 to provide a light-reflecting function. The supporting plate 210 may be composed of a nonmetal material, such as a plastic material mixed with glass fibers. The supporting plate 210 may be a flat plate, and is preferably a wavy or corrugated plate to further increase the structural strength of the rear frame module 200c. In the present exemplary embodiment, the wavy (corrugated) carrying plate 210 is set with a plurality of wavy structures 212. The shape of the wavy structures 212 may be circle wave, rectangular wave or triangular wave, and the wavy structures 212 preferably extend along a direction parallel to the longitudinal side of the frame, so that the structural strength of the supporting plate 210 perpendicular to the propagating direction 216 of the wavy structures 212 is increased, such as shown in FIG. 6C.

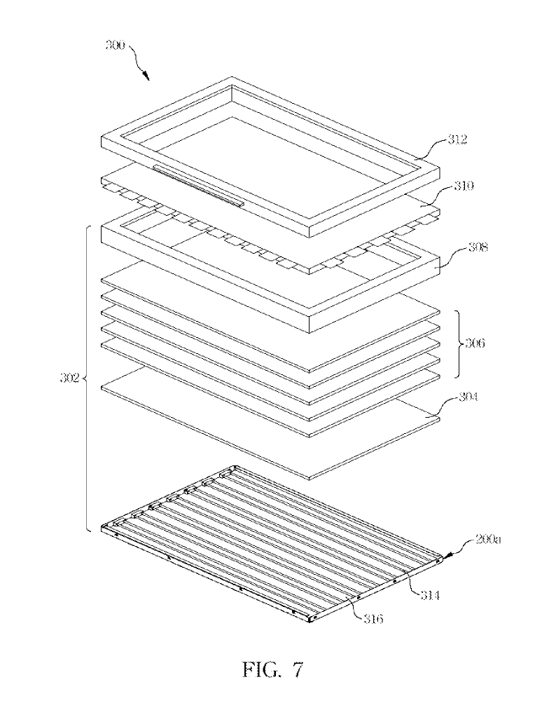

The rear frame module of the exemplary embodiment may be suitable to apply in a liquid crystal display including a direct type backlight module. For example, referring to FIG. 7, the rear frame module 200a described in the aforementioned embodiment can be applied in a liquid crystal display 300. The liquid crystal display 300 is mainly composed of a direct type backlight module 302 and a liquid crystal panel module 310, wherein the liquid crystal panel module 310 is stacked on the front of the backlight module 302. The backlight module 302 mainly includes the aforementioned rear frame module 200a and a light source 314 disposed on the front of the rear frame module 200a. The light source 314 may be composed of cold cathode fluorescent lamps (CCFLs) or light emitting diodes (LEDs). In order to enhance the efficiency of the light source 314, a reflection sheet 314 is selectively provided under the light source 314 of the backlight module 302 and is located between the rear frame module 200a and the light source 314, so as to reflect the light emitted toward the rear frame module 200a by the light source 314 toward the front of the backlight module 302 to effectively use the efficiency of the light source 314. Typically, in order to uniform the emitting light of the light source 314, a diffusive plate 304 is selectively disposed on the light source 314 on the front of the backlight module 302. In addition, in order to optimize the optical properties including brightness, visual angle and uniformity, an optical film set 306 including, for example a diffusive sheet, a brightness enhancement film (BEF) or a dual brightness enhancement film (DBEF), is selectively disposed on the diffusive plate 304 of the backlight module 302. A backlight module front frame 308 may be used to confine the edge of the optical film set 306 and is combined with the rear frame module 200a, so as to fix the components inside the backlight module 302.

The liquid crystal panel module 310 is usually composed of a thin film transistor substrate (TFT substrate), a liquid crystal layer and a color filter substrate (not shown) stacked in sequence. After the liquid crystal panel module 310 is stacked on the backlight module 302, a front frame 312 is disposed to confine the edge of the liquid crystal panel module 310 and is combined with the backlight module 302 to complete the fabrication of the liquid crystal display 300.

According to the aforementioned description, one advantage of the present invention is that the direct type backlight module uses a frame composed of several frameworks as the rear supporting structure of the backlight module, so that the weight of the rear frame module is effectively decreased, thereby lightening the backlight module and reducing the transport cost.

According to the aforementioned description, another advantage of the present invention is that the direct type backlight module may use metal frameworks or nonmetal frameworks to form the rear supporting structure to replace the conventional rear plate, so that the material cost is reduced and sufficient structural strength of the backlight module is maintained.

According to the aforementioned description, still another advantage of the present invention is that the backlight module of the liquid crystal display includes a rear frame module composed of frameworks, and the frameworks are composed of a high strength material, so that the material is used economically without degrading the structural strength of the rear frame module. Therefore, the waste of the material is reduced, the cost of the liquid crystal display is decreased, and the liquid crystal display is lightened.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A direct type backlight module, comprising:
a rear frame module comprising a plurality of frameworks, wherein the frameworks are combined to form a frame, wherein the rear frame module further comprises at least one auxiliary framework, and wherein two ends of the auxiliary framework are respectively connected to two opposite frameworks;
a light source disposed on the rear frame module;
a reflection sheet disposed between the rear frame module and the light source;
a diffusive plate disposed on the light source; and
an optical film set disposed on the diffusive plate.

2. The direct type backlight module according to claim 1, wherein a material of the auxiliary framework comprises metal.

3. The direct type backlight module according to claim 1, wherein the rear frame module further comprises a plurality of auxiliary frameworks, two ends of each auxiliary frameworks are respectively connected to the two opposite frameworks, and at least one of the frameworks is connected to one of the auxiliary frameworks adjacent to and juxtaposed with said framework.

4. The direct type backlight module according to claim 1, wherein the rear frame module further comprises a supporting plate disposed on the frame.

5. The direct type backlight module according to claim 4, wherein the supporting plate comprises a plurality of wavy structures, and the wavy structures are shaped as circular waves, rectangular waves or triangular waves.

6. The direct type backlight module according to claim 1, wherein the light source is composed of cold cathode fluorescent lamps (CCFLs) or light emitting diodes (LEDs).

7. A liquid crystal display, comprising:
a direct type backlight module comprising:
a rear frame module comprising a plurality of frameworks, wherein the frameworks are combined to form a frame, wherein the rear frame module further comprises at least one auxiliary framework, and wherein two ends of the auxiliary framework are respectively connected to two opposite frameworks;
a light source disposed on the rear frame module;
a reflection sheet disposed between the rear frame module and the light source;
a diffusive plate disposed on the light source; and
an optical film set disposed on the diffusive plate; and
a liquid crystal panel module disposed on the direct type backlight module.

8. The liquid crystal display according to claim 7, wherein a material of the auxiliary framework comprises metal.

9. The liquid crystal display according to claim 7, wherein the rear frame module further comprises a plurality of auxiliary frameworks, two ends of each auxiliary framework are respectively connected to said two opposite frameworks, and at least one of the frameworks is connected to one of the adjacent auxiliary frameworks adjacent to and juxtaposed with said framework.

10. The liquid crystal display according to claim 7, wherein the rear frame module further comprises a supporting plate disposed on the frame and connected with the frame.

11. The liquid crystal display according to claim 10, wherein the supporting plate is set with a plurality of wavy structures, and a shape of the wavy structures is circle wave, rectangular wave or triangular wave.

12. The liquid crystal display according to claim 10, wherein the wavy structures of the supporting plate extend along a direction parallel to a longitudinal side of the frame.

13. The liquid crystal display according to claim 7, wherein the light source is composed of cold cathode fluorescent lamps or light emitting diodes.

14. A liquid crystal display, comprising:
a direct type backlight module comprising:
a light source;
a rear frame module deposed under the light source, wherein the rear frame module comprises:
a plurality of frameworks, wherein the frameworks are combined to form a frame; and
a supporting plate disposed on the frame and connected with the frame, wherein the supporting plate includes a reflecting layer used to reflect light emitted by the light source;
a diffusive plate disposed on the light source; and
an optical film set disposed on the diffusive plate; and
a liquid crystal panel module disposed on the direct type backlight module.

15. The liquid crystal display according to claim 14, wherein the rear frame module further comprises at least one auxiliary framework, and two ends of the auxiliary framework are respectively connected to said two opposite frameworks.

16. The liquid crystal display according to claim 15, wherein the rear frame module further comprises a plurality of auxiliary frameworks, two ends of each auxiliary framework are respectively connected to said two opposite frameworks, and at least one of the frameworks is connected to one of the adjacent auxiliary frameworks juxtaposed with and adjacent to the framework.

17. The liquid crystal display according to claim 15, wherein the supporting plate is set with a plurality of wavy structures, and a shape of the wavy structures is circle wave, rectangular wave or triangular wave.

18. The liquid crystal display according to claim 17, wherein the wavy structures of the supporting plate extend along a direction parallel to a longitudinal side of the frame.
